(19) United States
(12) Patent Application Publication
(10) Pub. No.: US 2010/0139837 A1
(43) Pub. Date: Jun. 10, 2010

(54) Method and Apparatus for Making Fiber Composite Article

(75) Inventor: John R. Mott, Walkersville, MD (US)

Correspondence Address: CLARK & BRODY, 1700 Diagonal Road, Suite 510, Alexandria, VA, 22314, US

(73) Assignee: SPECIALTY COMPOSITES, LLC, Roswell, GA (US)

(21) Appl. No.: 11/989,422

(22) PCT Filed: Aug. 1, 2006
(86) PCT No.: PCT/US2006/029582

§ 371 Date: Jan. 25, 2008

Related U.S. Application Data
(60) Provisional application No. 60/704,442, filed on Aug. 2, 2005.

(51) Int. Cl. B29C 53/72; B29C 53/56; B29C 53/82; B29C 53/80

(52) U.S. Cl. 156/73.6; 156/173; 156/425; 156/580

(57) ABSTRACT

A fiber composite article is wound on a mandrel in a vertical orientation to ensure even tension in the fibers. Composite material is preferably glass fibers and cement. The fibers are applied by an assembly that moves in vertical and horizontal directions and the cement may be applied to the fibers before they are wound. After the fibers and cement are applied to the mandrel, the article is vibrated to allow escape of air and to ensure even coating of the fibers. The apparatus for vibrating the wound article includes a flexible sleeve that surrounds the article and moves vertically to apply a vibrating radial compacting force. The article may then be wound with tape to compress the applied glass fibers and cement prevent the loss of water during curing. A compressible sock is placed on the mandrel between the mandrel and the article for easier removal of the article.

### TECHNICAL FIELD

This invention relates to the art of fiber composite articles and the manufacture of such articles. In the preferred embodiments, the invention relates to glass fiber reinforced cement articles.

### BACKGROUND

Fiber composite articles are known. For example, U.S. Pat. No. 5,880,404 discloses a utility pole made of substantially continuous glass fibers and inorganic cement. Such a pole has many advantages, such as increased strength and durability, and inductive transparency. Manufacture of such poles to obtain a pole having the desired strength and durability and to meet cost objectives has been elusive.

One problem is that techniques known for winding glass fiber reinforced resin articles are not necessarily applicable to the winding of glass fiber reinforced cement articles, particularly poles. For example, resins are generally more conducive to winding techniques because the resin sticks to glass fibers readily making it relatively easy to wind fibers covered with resin around a mandrel to result in satisfactory fiber-resin matrix. The consistency of cements, however, is very different from that of resins, and it is generally more difficult to apply the glass fibers and cement in such a manner that the desired matrix results. The cement often traps more air and does not maintain the fibers in the desired position in the matrix.

Another problem that is particularly pronounced in the winding of poles results from the fact that the winding angle of the glass fibers, the angle of the fibers with respect to the longitudinal axis of the pole, is large. If the pole is wound with the axis of the pole horizontal, in accordance with known techniques, the result is a significant amount of sag in the fibers during winding and curing. This sag greatly complicates winding and results in a deformed product if the pole is allowed to cure in the horizontal orientation.

Accordingly, it is an object of this invention to provide methods for manufacturing glass fiber reinforced cement articles that overcome problems arising from use of the known winding techniques.

### SUMMARY OF THE INVENTION

In accordance with one aspect of the invention, a glass fiber reinforced cement article is manufactured by winding the glass fibers about a mandrel rotating about a vertical axis. Among other advantages, this technique subjects all of the fibers to gravitational forces that are symmetrical about the axis of the pole, which eliminates sag perpendicular to the pole axis. That provides a uniform configuration of the fibers about the longitudinal axis during winding and cure, which eliminates earlier problems resulting from rotationally non-uniform sag of the fibers. Moreover, winding an elongated article such as a pole about a vertical axis reduces or effectively eliminates the need to maintain tension in the fibers, which reduces the likelihood of breakage and increases winding efficiencies.

In accordance with another feature of the invention, cement is applied to the fibers by running them through a pan of cement that efficiently applies the cement to the fibers while eliminating excess cement before application to the article being wound.

In accordance with a further aspect of the invention, the uncured fiber-cement article is treated to ensure uniformity of the fiber-cement matrix and to eliminate air from the matrix. In a preferred embodiment, the uncured matrix is vibrated to render the normally thixotropic cement fluid to allow the cement to flow into voids in the uncured matrix. In a preferred embodiment, the uncured matrix is physically vibrated from one end of the article to the other, preferably, by moving a flexible sleeve encompassing a small longitudinal part of the article along the article while vibrating the sleeve. Thus, the vibrating sleeve liquefies the cement to allow it to flow into voids and smoothes the exterior of the article to provide the desired exterior finish.

If the wound article has been provided with excess cement during winding, the vibrating sleeve effectively removes the excess cement as it moves along the article. In other instances, however, it may be desirable to provide additional cement to the article after winding, and this may be done by providing additional cement to the vibrating sleeve as it moves along the article. In this latter case, the vibrating sleeve causes the additional cement to enter the uncured matrix, filling any voids in the wound glass fiber. In fact, it is contemplated that the fibers may be wound with a minimum amount of cement, or even dry wound, and the desired amount of cement subsequently provided by the vibrating sleeve.

In accordance with yet another aspect of the invention, the uncured article is finally wrapped with a water impervious tape that compresses the uncured material and prevents loss of water through evaporation, or otherwise, during cure. This has been found to increase the strength of the matrix.

To facilitate removal of the wound article from the mandrel, a compressible “sock” is placed over the mandrel prior to winding. This sock provides a barrier of variable thickness between the mandrel and the wound article to prevent tight engagement between the article and the mandrel and, thus, allow the article to be detached from the mandrel more easily.

### BRIEF DESCRIPTION OF THE DRAWINGS

FIG. 1 is a side view of a vertical winding apparatus in accordance with the invention.

FIG. 1A is a cross-section taken along line 1A-1A of FIG. 1.

FIG. 2 is a side view of a portion of the apparatus shown in FIG. 1 with winding bath shown partially broken away.

FIG. 3 a side view of a zone refining fixture in accordance with a second aspect of the invention.

FIG. 4 is a side view of a taping fixture in accordance with a further aspect of the invention.

### DETAILED DESCRIPTION OF THE PREFERRED EMBODIMENTS

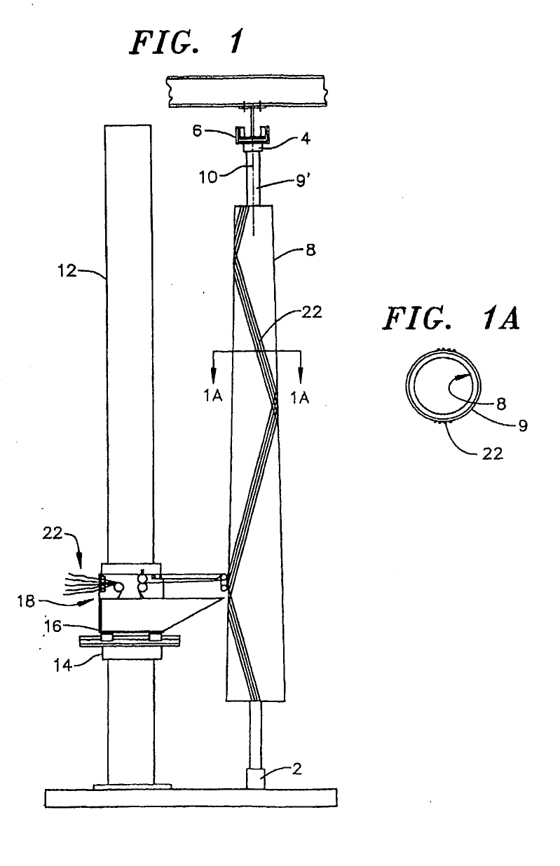

With reference to FIG. 1, a vertical winding apparatus in accordance with the invention comprises a three-axis winding machine for winding an elongate article, such as a pole, in accordance with the invention. The winding machine includes a base drive 2 mounted on the floor of a winding facility, or other convenient location. A top support bearing 4 is carried by a truck 6. A mandrel 8 is supported by the bearing 4 for rotation, and the mandrel engages a shaft from the base drive to allow the base drive to rotate the mandrel about an axis of rotation 10 extending between the bearing 4 and the base drive 2. Axis 10 is preferably vertical but may have other orientations. The mandrel 8 may be driven other than by the drive base, for example by a motor mounted at the top of the mandrel.

A mast assembly 12 is mounted adjacent the base drive and extends generally parallel to axis 10. The mast assembly carries a carriage 14 for movement along the mast. The carriage includes a transverse table 16 that moves transverse to the direction of axis 10 for movement toward and away from the mandrel 8.

A winding assembly 18 is mounted to the transverse table for movement with the table toward and away from the mandrel. The elements of the winding assembly will be described in detail below, but it is noted here that the winding assembly receives glass fibers from a source (not shown) and directs the fibers through a cement bath, pinch rollers that remove excess cement, and then through a payout eye that applies the fibers to the mandrel accurately.

In operation, the carriage 14 is driven along the mast 12 in a direction parallel to axis 10 while the winding assembly is driven in a transverse direction to apply the fibers to the mandrel 8.

The motion of the mandrel, the carriage and the transverse table are preferably electronically controlled by a computer programmed to provide coordinated motions to result in the desired winding pattern. A major feature of the winding pattern is the angle of the fibers with respect to the axis 10. In a preferred embodiment, that angle is eleven to fifteen degrees.

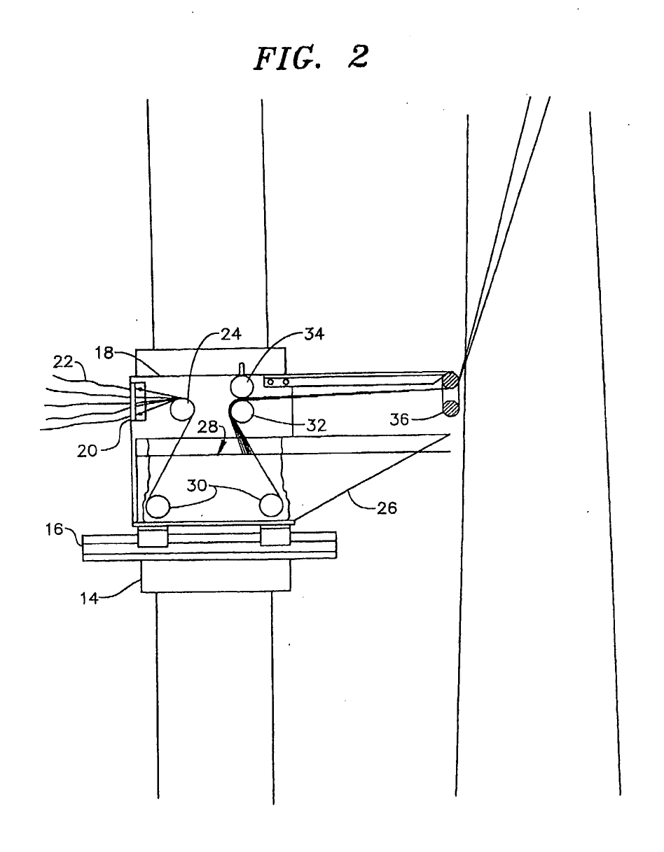

FIG. 1A illustrates a preferred technique of reducing the tendency of the wound article to stick to the mandrel. A “sock” 9, made of 1/16 to ⅛ inch thick polyethylene foam sheet, is wrapped with PVC tape to provide a compressible layer. The mandrel, which has been previously painted and waxed, is dusted with a dry lubricant (e.g., talc), and the sock is then pulled over the mandrel before initiating winding. The fibers 22 (see FIG. 2) are wound over this sock. Because the sock is compressible, any contraction of the wound article during cure will be absorbed by the sock and thereby prevent excessive adherence to the mandrel 8.

Removal of the mandrel is further facilitated by removing air remaining in the gap between the sock and the mandrel, for example, by connecting a vacuum pump to the gap after cure of the article and during removal of the mandrel. Additionally, it may be desirable to provide the sock with one or more circumferentially spaced axial ribs (e.g., fiberglass tape with high tensile strength) for pulling the sock and article off the mandrel.

Referring now to FIG. 2, the carriage 14 is mounted to the mast 12 for movement along the mast in any of a variety of ways. For example, the carriage may be connected to a chain driven along the mast by a motor mounted at the bottom of the mast. The transverse table is driven toward and away from the mandrel, for example, by a motor turning a ball screw. The winding assembly 18 comprises an entry comb 20 that receives strands 22 of glass fiber and directs the strands to a first rod 24, which directs the fibers into the cement bath 26 containing cement 28. The fibers 22 enter the cement 28 and pass beneath stationary rods 30 and exit the cement to engage a stationary pinch rod 32 and a movable pinch rod 34. The pinch rods remove excess cements from the fibers and direct them to the payout eye 36. The movable pinch rod is mounted for vertical motion with respect to the stationary pinch rod 32, and the vertical force applied to the fiber is preferably provided by the weight of the rod 34. Other mechanisms for providing a desired pinching force will be apparent to those of skill in the art.

It will also be appreciated that in the arrangement of FIG. 2, the pinch rod 32 causes the fibers to turn in a direction opposite to that caused by rods 24 and 30. The cement is naturally pulled out of the bath somewhat, and the reverse turn ensures that all sides of the fiber are coated with cement.

In a further embodiment, the bath 26 may be provided with a moving bar (sliding or rotating) or other element that stirs the cement to re-suspend solid material that may have settled out of the cement during prolonged operation.

Additionally, a pump is preferably provided to supply the bath with cement from a remote container. This maintains the level of the cement in the bath relatively constant, which results in a more even product because all fibers are exposed to the same amount of cement.

In a still further embodiment, the fiber-contacting elements of the bath, such as the pinch mechanism and the payout eye, are vibrated to maintain fluidity and improve the wetting of the fiber by the cement.

The position of the payout eye with respect to the mandrel is important and is controlled by motion of the transverse table. The objective is to maintain accuracy of the wind pattern and the efficiency of the winding. In the preferred embodiment, the fibers are wrapped over the ends of the mandrel during the winding. That is, the fiber is placed on the mandrel as the mandrel rotates and the carriage 14 moves along the mast. The payout eye is moved toward or away from the mandrel in coordination with this motion to apply the fiber to the surface of the mandrel in the desired pattern. When the payout eye reaches one end of the mandrel, the transverse table moves the payout eye radially inward whereby the fibers pass over the end of the mandrel 8 and around the mandrel shaft 8′. The fibers are then applied back along a reverse course on the mandrel.

In an alternative arrangement, radial pins (not shown) are mounted on the ends of the mandrel 8, for example by a circular ring with the pins extending outwardly, to receive and support fibers at the ends of the winding courses.

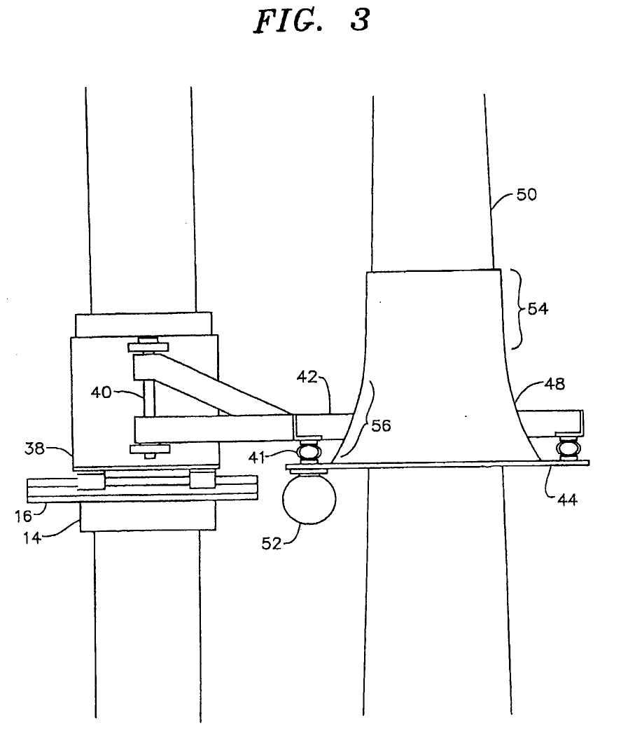

Referring now to FIG. 3, a zone refining fixture is mounted to a carriage 14 and transverse table 16 by a mounting plate 38 and a pivotal connection 40. A mounting yoke 42 engages the pivotal connection and supports a ring 44 through vibration isolators 41. A sleeve 48 is mounted to the ring to engage the wound article 50. The sleeve operates like a squeegee to squeeze and compact the wound fiber cement article and to remove entrapped air and excess cement and to impart a smooth external surface to the article. Preferably the sleeve is made of an elastic polymer of sufficient elasticity and resilience to apply radial forces to the article while accommodating the increase in diameter for a longitudinally tapered article. In a preferred embodiment, the sleeve is made of a silicone sold under the trademark “Dragon Skin” by Smooth-On Corporation.

The sleeve has an upper portion 54 that engages the wound article to apply the desired radial compacting force and a flared entry 56 end having a flange that is attached to the ring 44.

A vibrator 52 is mounted on the ring 44 and vibrates the ring and sleeve 48. This vibration takes advantage of the thixotropic properties of the cement to create a narrow liquefied zone in the wound article. In use, the sleeve is placed on the upper end of the wound article and moved downward to liquefy and compress successive zones of the wound article as the sleeve is drawn downwardly over the would article, and the wound article oscillates slowly back and forth through a fairly narrow angle closely approximating the wound part's wind angle or slightly greater. This causes the cement in the zones to fill any voids in the article and also removes air and excess cement. Further, liquefying the cement in the zones after winding, allows the tensions in the fibers to equalize, thus producing a better product. It may be noted that a further advantage of winding the article in a vertical orientation is that the tensions in the fibers are equalized circumferentially because the gravitation forces on the fibers are axially symmetric, and this is further enhanced during application of zone refining.

In a further embodiment, the elastic polymer sleeve is further enhanced by elastic bands on the exterior of the upper section of the sleeve to increase the radially inward force and further compact the fiber cement. These bands must be periodically adjusted, manually or otherwise, during the downward course of travel to accommodate the taper of the fiber cement pole and mandrel. In a further embodiment, the upper section of the sleeve can be fitted with a sleeve-like bladder inflated with gas or fluid to achieve the desired inward compression. In a further embodiment, the bladder is pressurized with a fluid to obtain the desired compression and vibrated simultaneously by using an external vibrator and a connecting hose suitable for applying vibrations at variable force and frequency. In a further embodiment, the elastic sleeve and its attached ring may be replaced by a disk diaphragm valve. A disk diaphragm valve works by twisting the ends of a polymer-impregnated fabric sleeve in opposite directions creating an hourglass shape and eventual closure. By this method, the radially-inward compression is provided not by an elastic polymer but by application of a force to the valve's closing mechanism thereby providing a twisting motion to the valve's fabric sleeve and effecting the desired compression effect. This force can be modulated by using a controller in a force feedback arrangement, for example, by monitoring the motor current driving the carriage movement on the mast while zone refining.

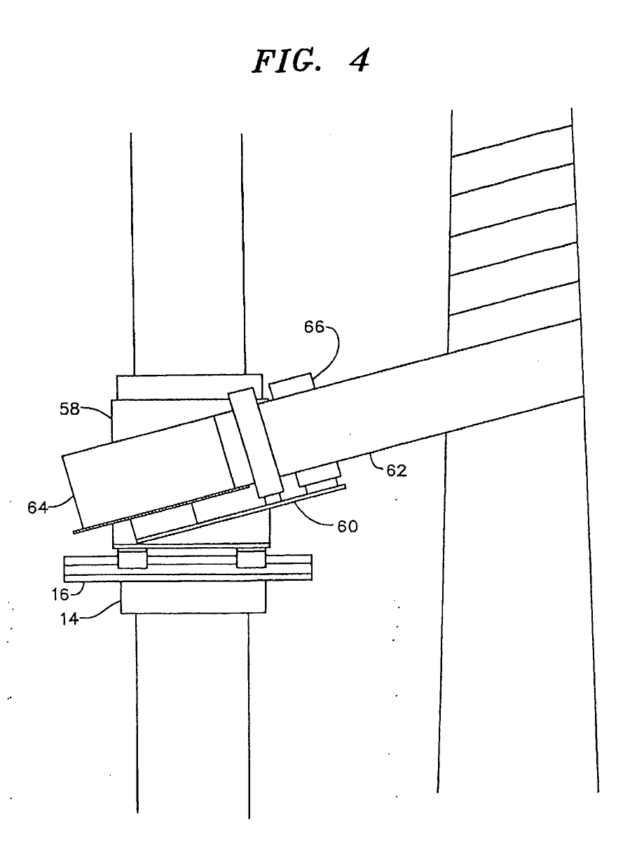

FIG. 4 illustrates a taping fixture 60 for applying tape 62 to the exterior of a wound article. The taping fixture is mounted to a plate 58, which may be attached to the traverse table 16, the fixture being mounted for pivotal motion, about a horizontal axis. Tape 62 (e.g., polyethylene) is supplied from a roll 64 carried on a spindle controlled by a brake whereby a desired force can be applied to the tape during its application. Preferably, tape tension is measured by a transducer roller 66. The brake is controlled by signals received from the transducer roller in a closed-loop feedback circuit to obtain the desired tension. The tape is helically wound on the surface of the wound article by moving the carriage 14 along a mast 12 as the wound article rotates in accordance with a predetermined motion-control program. The purpose of the taping is to compact the cement to increase the strength of the ultimate product and provide a smooth exterior finish.

While various cement compositions may be used, the preferred cement is a Portland cement that does not include materials that reduce the strength of the fibers. For example a sand-free cement composition such as that disclosed in U.S. Provisional Patent application 60/703,460 is preferred. The present invention, however, is not limited to the use of such materials, and the embodiments disclosed above may be applicable to a variety of articles and a variety of materials used for winding glass fiber reinforced articles.

Modifications will be apparent to those of skill in the art and variations can be made without departing from the spirit or scope of the invention. Thus, the embodiments disclosed in this specification along with other embodiments of the present invention include these modifications and variation provided they fall within the scope of the claims and their equivalents.

What is claimed is:

1. A method for making a fiber composite article comprising the steps of:
providing a mandrel mounted for rotation about a substantially vertical axis;
applying a plurality of glass fibers to said mandrel to form the article as said mandrel rotates, and
applying cement to said glass fibers.

2. The method of claim 1 wherein said step of applying a plurality of glass fibers comprises directing said fibers to a payout eye positioned relative to the vertical axis.

3. The method of claim 1 wherein said step of applying cement comprises directing said plurality of glass fibers through a cement bath prior to applying said plurality of glass fibers to said mandrel.

4. The method of claim 3 further comprising directing said fibers to pinch rods to remove excess cement.

5. The method of claim 2 wherein said step of applying a plurality of glass fibers includes moving the payout eye parallel to the vertical axis along a length of the article.

6. The method of claim 1, further comprising stirring cement within the cement bath.

7. The method of claim 1, further comprising squeezing the applied plurality of glass fibers forming the article with a sleeve.

8. The method of claim 1, further comprising vibrating the applied plurality of glass fibers on the article.

9. The method of claim 2 wherein said cement is

10. A winding assembly comprising:
a table movable in a transverse direction to a vertical axis;
a first rod to direct a plurality of glass fibers to at least one stationary rod in a cement bath;
a pair of pinch rods to engage the plurality of glass fibers and to remove excess cement, wherein the plurality of glass fibers turn in a direction opposite that caused by the first rod; and
a payout eye having a position controlled by the table to vertically apply the plurality of fibers.

11. The winding assembly of claim 10, wherein the pair of pinch rods includes a movable pinch rod and a stationary pinch rod, wherein the stationary pinch rod is configured to turn the plurality of glass fibers.

12. The winding assembly of claim 10, wherein the payout eye applies the plurality of glass fibers to form a winding pattern having an angle of about 11 degrees to about 15 degrees with respect to the vertical axis.

13. The winding assembly of claim 10, wherein the table moves the payout eye in the transverse direction.

14. The winding assembly of claim 10, further comprising a carriage to move the table along the vertical axis.

15. A winding apparatus comprising:
a sleeve to surround a wound article and moveable along a vertical axis, wherein the sleeve is configured to apply a compacting force to the wound article;
a ring coupled to the sleeve; and
a vibrator mounted on the ring to vibrate the sleeve.

16. The vertical winding apparatus of claim 15, wherein the sleeve includes an upper portion to engage the wound article to apply the compacting force.

17. The vertical winding apparatus of claim 15, further comprising a mandrel to support the wound article on the vertical axis.

18. A method for refining a wound article, the method comprising:
moving a sleeve along the wound article, wherein the sleeve surrounds the wound article;
applying a compacting force to the wound article with the sleeve; and
vibrating the sleeve to oscillate the wound article.

19. The method of claim 18, further comprising squeezing the wound article with the sleeve.

20. The method of claim 18, further comprising removing excess material from the wound article.

21. The method of claim 18, wherein the wound articles comprises a wound fiber cement article.

22. The method of claim 18, wherein the applying includes compressing the wound article.

23. The method of claim 18, further comprising varying the compacting force.

24. The method of claim 18, further comprising applying tape to an exterior of the wound article.

25. The method of claim 24, further comprising vertically moving a. taping fixture to apply the tape.

26. The method of claim 18, further comprising applying additional material to the wound article via the sleeve.

27. A system for making a composite article, the system comprising:
a mandrel having a vertical orientation to support the composite article, wherein a sock is located between the mandrel and the composite article;
a winding assembly to apply a plurality of glass fibers bathed in cement comprising the composite article, wherein the winding assembly includes a plurality of rods to turn the plurality of glass fibers in a desired direction and a payout eye moveable in a direction transverse to the vertical orientation to apply the plurality of glass fibers in a pattern on the composite article;
a refining assembly comprising a sleeve surrounding the composite article to smooth surface of the composite article; and
a taping fixture to apply tape to an exterior of the composite article.
